(19) United States
(12) Patent Application Publication
(10) Pub. No.: US 2006/0117549 A1
(43) Pub. Date: Jun. 8, 2006

(54) Method for process control or process regulation of a unit for moulding, cooling and/or thermal treatment of metal

(76) Inventors: Uwe Plocoennik, Ratingen (DE); Christian Plociennik, Ratingen (DE); Karl-Ernst Hensger, Dusseldorf (DE)

Correspondence Address: FRIEDRICH KUEFFNER, 317 MADISON AVENUE, SUITE 910, NEW YORK, NY, 10017, US

(21) Appl. No.: 10/537,521

(22) PCT Filed: Nov. 19, 2003
(86) PCT No.: PCT/EP03/12918

§ 371 Date: Jun. 3, 2005

(30) Foreign Application Priority Data
Dec. 5, 2002 (DE) 102 56 750.6

(51) Int. Cl. H01S 4/00

(52) U.S. Cl. 29/592.1

(57) ABSTRACT

According to the invention, a method for process control or process regulation of a unit for moulding, cooling and/or thermal treatment of metal, in particular for steel or aluminium, whereby the unit is provided with actuators for setting particular operating parameters and the method process is based on a method model can be achieved, with which it is possible to adjust online desired structural features and, by using structural property relationships, desired material properties can be adjusted, whereby at least one current value predictive of the metal structure is recorded online and, depending on said value, suitable process control and/or process regulation parameters for acting on the actuators to set desired structure properties of the metal are determined using a structural model and the method model on which the process is based.

The invention concerns a method for the process control or process regulation of an installation for the shaping, cooling, and/or heat treatment of metal, especially steel or aluminum, wherein the installation is equipped with actuators for setting specific operating parameters and the method process is based on a method model.

Operating parameters are understood to be, for example, the roll adjustments in a rolling line or the cooling parameters in a cooling line.

DE 199 41 600 A1 and DE 199 41 736 A1 describe methods for process control and process optimization in the hot rolling of metal, wherein the electromagnetic radiation emitted by the hot metal is detected online as a spectrum and evaluated or wherein the electromagnetic radiation emitted by an x-ray source penetrates the metal, in this case, a metal strip, and is detected online on the reverse side of the metal strip and evaluated, crystallographic and/or microstructural transformations and/or chemical transformations that occur at certain temperatures of the metal are determined by the evaluation, and, depending on the degree or course of the transformation, suitable process control and/or process regulation variables for process optimization are derived, and/or an online adaptation of the process models is carried out.

It is also known that the process control can be carried out solely by means of microstructural models. According to WO 99/24182, the operating parameters of a metallurgical installation for the treatment of steel or aluminum are determined by means of a microstructure optimizer as a function of the desired material properties of the metal. The material properties and useful properties to be expected are determined by means of a microstructure observer. This is followed by a comparison between set values and the values determined by the microstructure observer for the material properties and useful properties. If there is a difference between the observed or calculated values and the determined values, the operating parameters, such as the inlet and outlet temperatures of the rolling line and the degrees of reduction, are changed.

In addition, WO 99/24182 explains the changes in the microstructure of steel during rolling, while DE 199 41 600 A1 and DE 199 41 736 A1 describe the γ-α microstructural transformation of steel in detail.

The objective of the invention is to provide a method for the process control or process regulation of an installation for the shaping, cooling, and/or heat treatment of metal, especially steel or aluminum, with which it is possible systematically to set desired microstructural characteristics online and desired material properties with the use of microstructural property relationships.

This objective is achieved by the method with the features of claim 1. Advantageous modifications are described in the dependent claims.

With respect to the method, it is proposed that at least one current value that provides information about the microstructure is detected online, and, depending on this value, suitable process control and/or process regulation variables for acting on the installation actuators are determined with the use of a microstructure model that describes the solid-state reactions that occur during the shaping, cooling, and/or heat treatment and with the use of the method model that is the basis of the process and that serves to ensure the automated process sequence. To this end, the detected current actual microstructural characteristic value is compared with a preset desired value, and a resulting difference is used as a regulation variable for the process with the use of microstructure and method models.

The objective is achieved by systematically combining the method model, an online detection of at least one current microstructural characteristic value, for example, at the end of the process to be controlled, and a microstructure model. With respect to the method, the prediction models should include a microstructure model, i.e., a prognosis model for predicting the solid-state reactions that occur during a shaping operation, for example, in the rolling mill, or during a cooling operation in the cooling line, and for predicting the microstructural characteristics that develop during these reactions.

Preferably, an online adaptation of the method model and/or the microstructure model should be carried out as a function of the detected value that provides information about the microstructure. If a comparison of the actual value and the set value reveals a difference that exceeds a certain value, a new computation of the method model (for example, the model of the rolling pass program or the cooling line model) and of the microstructure model is carried out.

A current microstructural grain size value and/or a microstructural transformation time or the microstructural transformation time interval is preferably detected as the value that provides information about the microstructure.

The current microstructural characteristic value, especially a microstructural grain size value, is preferably detected by means of nondestructive materials testing instruments, such as ultrasonic measuring instruments, especially laser-generated ultrasonic measuring instruments, and x-ray instruments.

Preferably, measuring devices that contact the metal should be used for detecting microstructural transformations. These include rolling force measuring devices and measuring rollers for detecting expansion stresses and tensile stresses that act on the metal strip during shaping. The linear expansion of the metallic lattice of the steel that is associated with the γ-α transformation can thus be detected by these contacting measuring instruments as a measure of the microstructural transformation.

In accordance with another embodiment, the transformation temperature is detected online as the value that provides information about the microstructure by means of one or more temperature detection units, which are arranged longitudinally with respect to the direction of metal conveyance in a way that allows their relative movement and are positioned as a function of the expected site of the microstructrual transformation predicted by the microstructure model. Preferably, several temperature detection units are provided.

The proposed method is described in greater detail below on the basis of preferred embodiments.

The austenitic grain size of the microstructure of the metal to be treated is predetermined for the steel group of a C—Mn steel at a certain process time or at a certain site in the process with the use of microstructure models, which start from the chemical composition, and taking the rolling pass program in the rolling mill into consideration. The current austenitic grain size of the metallic microstructure is detected online (in this case, in a rolling process) without contact and nondestructively after the last rolling stand of the rolling train. The currently detected austenitic grain size value is compared with a predetermined set value for the size of the austenitic grain at this location in the process. If the actual value deviates from the set value, the difference is used to derive a correction-value, which is supplied to the actuators of the rolling train to control the actuators by means of the microstructure and method model on which the rolling train is based. If, for example, the measured austenitic grain size is smaller than a set value, a correction value is supplied to the actuators for the intermediate stand cooling of the rolling train in order to reduce the intermediate stand cooling and thus increase the final rolling temperature. By increasing the final rolling temperature, the austenitic microstructure at the end of the rolling train is adjusted to a larger grain size. Since even small changes in the final rolling temperature have a significant effect on the austenitic grain size, there is still enough time for the control or regulation of the installation to affect the metal strip or sheet currently being treated, i.e., the grain size can be adjusted to the set value in the same strip.

In another preferred variant of the method, the current value that provides information about the microstructure is detected online during the process of treating the metal by shaping, cooling, and/or heat treatment at a certain point, i.e., at stand (n) or pass (n), with systematic control of the process parameters for the preceding stand (n−1) or pass (n−1) as a function of the comparison that is made between the actual value and the set value.

For example, the microstructural grain size of the metal strip or metal sheet is detected, e.g., with an ultrasonic instrument, before shaping in stand (n) of a hot wide strip rolling train or before shaping in pass (n) of a plate rolling train. If the deviation of the actual value from a set value is too great, the method model, especially the model for the rolling pass program and the microstructure model, is recomputed with effects on the control signals for the actuators of the preceding stands or the actuators for carrying out the preceding passes, so that the desired set quantity can be achieved. The readjustment of the preceding stands can be accomplished online for the strip or sheet currently being rolled and/or can be used for the following strip or sheet.

In accordance with another preferred variant of the method, online microstructural control is carried out in a cooling line of a wire mill with a water-cooled segment of the cooling line and an air-cooled segment of the cooling line. In this method, a current microstructural grain size value, in this case, the austenitic grain size, of the metal wire is detected after passage through the water-cooled segment of the cooling line by means of an ultrasonic measuring instrument, and the temperature of the microstructural transformation and the course of the microstructural transformation, i.e., the γ-α transformation, with respect to time is detected with temperature measuring devices that can be moved and/or variably oriented in the direction of conveyance. If the detected values deviate from the planned set values, a recomputation is performed with the use of the cooling line model and microstructure model, and an appropriate adjustment of the actuators of the cooling line is made online.

The proposed online microstructural control or regulation can be applied not only to hot wide strip mills and possibly thin slab rolling mills, plate mills, section mills, bar mills, and wire mills, but also to cold strip mills and aluminum mills.

1. Method for the process control or process regulation of an installation for the shaping, cooling, and/or heat treatment of metal, wherein the installation is equipped with actuators for setting specific operating parameters and the method process is based on a method model, and wherein at least one current value that provides information about the metal microstructure is detected online, and, depending on this value, suitable process control and/or process regulation variables for acting on actuators for adjusting desired microstructural properties of the metal are determined with the use of a microstructure model and with the use of the method model that is the basis of the process.

2. Method in accordance with claim 1, characterized by the fact that an online adaptation of the method model and/or the microstructure model is carried out as a function of the detected value that provides information about the microstructure.

3. Method in accordance with claim 1, characterized by the fact that a current microstructural grain size value is detected as the value that provides information about the microstructure.

4. Method in accordance with claim 3, characterized by the fact that the austenitic grain size is determined as the microstructural grain size value.

5. Method in accordance with any of claims 1 to 4, characterized by the fact that a current microstructural grain size value is detected at the end of the installation for the shaping, cooling, and/or heat treatment of metal.

6. Method in accordance with any of claims 1 to 5, characterized by the fact that a current microstructural grain size value is detected during the process for shaping, cooling, and/or heat treatment of metal, and the process control or process regulation variables determined as a function of this value act on the actuators of preceding process steps.

7. Method in accordance with any of claims 1 to 6, characterized by the fact that a microstructural transformation time or the microstructural transformation time interval is detected online as the value that provides information about the microstructure by means of measuring devices in contact with the metal.

8. Method in accordance with any of claims 1 to 7, characterized by the fact that the transformation temperature is detected online as the value that provides information about the microstructure by means of one or more detection units, which are arranged longitudinally with respect to the direction of metal conveyance in a way that allows their relative movement and are positioned as a function of the expected site of the microstructrual transformation predicted by the microstructure model.

9. Method in accordance with claim 8, characterized by the fact that several detection units are used to detect the site or the time interval of the beginning and end of the microstructural transformation.

10. Method in accordance with any of claims 1 to 9, characterized by the fact that online microstructural control is carried out in a cooling line of a wire mill with a water-cooled segment of the cooling line and an air-cooled segment of the cooling line, wherein a current microstructural grain size value of the metal wire is detected after passage through the water-cooled segment of the cooling line by means of an ultrasonic measuring instrument, and wherein the temperature of a microstructural transformation and the course of the microstructural transformation, especially the γ-α transformation of steel, with respect to time is detected with temperature measuring devices that can be moved in the direction of conveyance and/or variably oriented.
